(19) United States
(12) Patent Application Publication
(10) Pub. No.: US 2005/0005058 A1
(43) Pub. Date: Jan. 6, 2005

(54) Interleaving management method for upgrading data processing speed

(76) Inventors: Wee-Kuan Gan, Hsinchu Hsien (TW); Soo-Ching Ng, Hsinchu Hsien (TW)

Correspondence Address: BIRCH STEWART KOLASCH & BIRCH, PO BOX 747, FALLS CHURCH, VA, 22040-0747, US

(21) Appl. No.: 10/609,373

(22) Filed: Jul. 1, 2003

(51) Int. Cl. G06F 12/08

(52) U.S. Cl. 711/103; 711/157; 711/203

(57) ABSTRACT

An interleaving management for upgrading the operation speed of flash memory cell is provided. A mother and child concept is applied to process the data of a flash memory cell. The so-called mother and child are two physical features own one logical address at the same time to allow the host to write to a logical address. Thus the controller need not repeat the transferring and erasing actions while writing data to the flash memory cell, accordingly the life of the flash memory cell can be extended and the processing speed can be substantially upgraded.

### BACKGROUND OF THE INVENTION

1. The Field of the Invention

The present invention generally relates to a new interleaving management method, and more particularly, the interleaving management method for managing data processing in a plurality of flash memory cells for upgrading data processing speed and thereby saving the time and also increasing the life of the flash memory cells. The method of the present invention can be suitably applied in any hosting device comprised of a portable ROM, a card reader in USB 1.1 series, or a portable ROM, a card reader in USB2.0 series, or an IDE/PCMCIA interface.

2. Description of the Related Art

The currently available information processor comprises a host with the prompt data processing transmission speed, the speed, for example, of a USB2.0 port is 480 mbs, IEEE1394 is 800 mbs, and the IDE interface is 16.66 mbs.

Flash memory cell is a non-volatile solid state memory that maintains data even after all power sources have been disconnected. Flash memory cell has been widely used in personal computers and other electronic equipment because of its programmable features allowing writing, erasing and reading data a number of times. When a read/write operation is to be performed on a certain sector of the active window of a flash memory cell, it would involve many stages of operations. If there are two sectors to be accessed, the conventional method is to execute the read/write operation on the first sector until all the stages are completed and then proceed to the read/write operation on the next sector. This sequential access method is undoubtedly low in efficiency. Accordingly, a substantial amount of time is required for read/write operations.

To write/erase the data in the flash memory cell, a bias voltage is applied to the drain in order to push electrons into the floating gate or pull electrons out of the floating gate by Fowler-Nordhem tunneling. To read the data in the flash memory cell, a working voltage is applied to the control gate to determine whether the channel is on or off (“1” or “0”). The value of the data (“0” or “1”) depends on the amounts of electrons trapped in the floating gate, which affect the status of the channel. For example, when the flash memory cell executes the erase step, the value of the data of the corresponding block will be 1, and when the flash memory cell executes the write step, the value of the data will be changed from 1 to 0 but however the value of the data cannot be changed from 0 to 1. During the erase step, a whole block is selected as a unit, therefore the controller selects the whole block as a unit. During file management operation, the controller often continuously renew the file arrangement table of the flash memory cell, when the data to be written are all for small files and the flash memory cell can only process data of few blocks, then the flash memory cell needs to keep on finding new blocks for transferring the data from the old block to the new block and erase the data in the old block.

If the standby data consist of few continuous sectors, i.e. two or more than two sets of data need to be written to the flash memory cell, the controller will find a new block first. Referring to FIG. 1A, illustrates a conventional controller is ready for writing two sets of data from page 3 of block 0 into the flash memory cell.

Referring to FIG. 1B, the conventional controller processes the first set of data, in a manner that the data in page 3 is processed first, and then this data is transferred from the corresponding page from the old block to the new block.

Referring to FIG. 1C, the conventional controller writes the data into page 3, which is to be written into the corresponding page.

Referring to FIG. 1D, the conventional controller writes the data into page 4, however the controller will not immediately transfer the rest of the pages of the old block to the new block, instead the controller continues to write data into the next page.

Referring to FIG. 1E, the conventional controller transfers the block below page 4 from the old block to the new block, after finishing writing all the data then transfers the rest of the blocks completely from the old block to the new block.

Additionally, referring to FIG. 1F, the conventional controller erases the old block and allows the new block replace the old block 0.

Because of the physical characteristics of the flash memory cell, the programmable feature of the flash memory cell allows reading, writing and erasing for about one million times. Therefore, to extend the life of the flash memory cell is obviously to reduce the number of erasing processes.

The flash memory cell used in a manner described above will certainly increase the chance for the flash memory to break down. Therefore, it is highly desirable improve the file management with the view of reducing the number of erasing steps so that the life of the flash memory cell is not only prolonged but also this would significantly increase the operation speed of the flash memory cell.

For increasing the operation speed, the flash memory cell has a new command so called “Copy Back” is used, because the data stored in the flash memory cell needs to be transferred often, thus the actions of read and write are constantly required, and therefore the flash memory cell will be busy operating all the time. The command “Copy Back” commands the flash memory to hold the data in the buffer instead of reading out, and next a command “Copy Back Write”, allows the data that is temporarily stored in the internal buffer to be written into the flash memory cell, and the time to accomplish this action is substantially shorter compared to the conventional reading and writing process.

However, the conventional Copy Back command has a drawback because the flash memory cells that recognize this command must have four different planes, and the Copy Back command is accepted only in the planes. These planes are located in a sequence of the block, for example, Plane 0 comprises Block 0, 4, 8 . . . , 1020 of all the zones, in other words, Plane 0 comprises all the blocks of the physical feature address of 4n+0 (0≦n≦255); and Plane 1 comprises block 1, 5, 9 . . . , 1021 of all the zones, in other words, Plane 1 comprises all the blocks of the physical feature address of 4n+1 (0≦n≦255), Plane 2 comprises block 2, 6, 10 . . . , 1022 of all the zones, in other words, Plane 2 comprises all the blocks of the physical feature address of 4n+2 (0≦n≦255), Plane 3 comprises block 3, 7, 11 . . . , 1023 of all the zones, in other words, Plane 3 comprises all the blocks of the physical feature address of 4n+3 (0≦n≦255). Thus the arrangement and file management of blocks are different from the conventional file management, in the controller, the zone 0 of the present invention is different from the actual block containing in zone 0 of the flash memory cell, and the blocks contained in zone 0 are block 4n+0 (0, 4, 8, . . . , 1020) of the actual zone 0, zone 1, zone 2 and zone 3 of the flash memory cell.

### SUMMARY OF THE INVENTION

Accordingly, in the view of the foregoing, the present inventor makes a detailed study of related art to evaluate and consider, and uses years of accumulated experience in this field, and through several experiments, to create a interleaving management method for managing data processing in a plurality of flash memory cells for upgrading data processing speed and thereby saving the time and also increasing the life of the flash memory cells.

According to one aspect of the present invention, a plurality of flash memory cells are used to co-manage interleaving flash memory cells to upgrade the processing speed and shorten the time for transferring the data, and to further extend the life of the flash memory cell.

According to another aspect of the present invention, a mother and child concept is applied to process the data of a flash memory. The so-called mother and child are two physical features owning one logical address at the same time to allow the host to write to a logical address. The controller defines the physical block that corresponds to the logical block as the mother block, then unify the mother block with the corresponding logical block wherein the back up logical zone, if the host is going to write to page N, the controller will move from block 0 to block N−1 from the mother block to the child block; then begins to write from block N of the child block. After finishing processing the data, the controller will not immediately move the rest of blocks from the mother block to the child block, instead waits until the host begins to write for the next time and judging whether to continue writing from the same address, if yes, then there is no need for the controller to find a new block, instead directly writes into the very block, after finishing writing all the pages of the child block, the controller will erase the mother block, and then replaces the mother block completely by the child block. Thus the controller need not repeat the transferring and erasing actions while writing data to the flash memory cell, accordingly the life of the flash memory cell can be extended and the processing speed can be substantially upgraded.

Because the data in the flash memory cell can only be changed from 1 into 0, and therefore for writing the whole data of a sector into a page, the controller needs to check whether that page is empty. The so-called empty means the value of the existing data in this block is 1, so for the convenience and safety, the controller has to find a new block (empty block, also called back up block) for writing the new data to the corresponding page of the block. And the rest of the pages will be moved to the new block from the old block, then erase the block and replace with the new block.

According to another aspect of the present invention, the structure of using interleaving management method to manage the flash memory cell can also be suitably applied in any hosting device, comprising a portable ROM, a card reader in USB1.1 series, or a portable ROM, a card reader in USB2.0 series, or an IDE/PCMCIA interface.

According to another aspect of the present invention, a plurality of flash memory cells are used to co-manage interleaving flash memory cells to promote the processing speed and shorten the time for transferring the data, and also to further extend the life of the flash memory cells.

### BRIEF DESCRIPTION OF THE DRAWING

The invention can be more fully understood by reading the following detailed description of the preferred embodiments, with reference made to the accompanying drawings, wherein:

FIG. 1A is an operation process flowchart (1) of a conventional method for writing two sets of data into page 3 of the block 0;

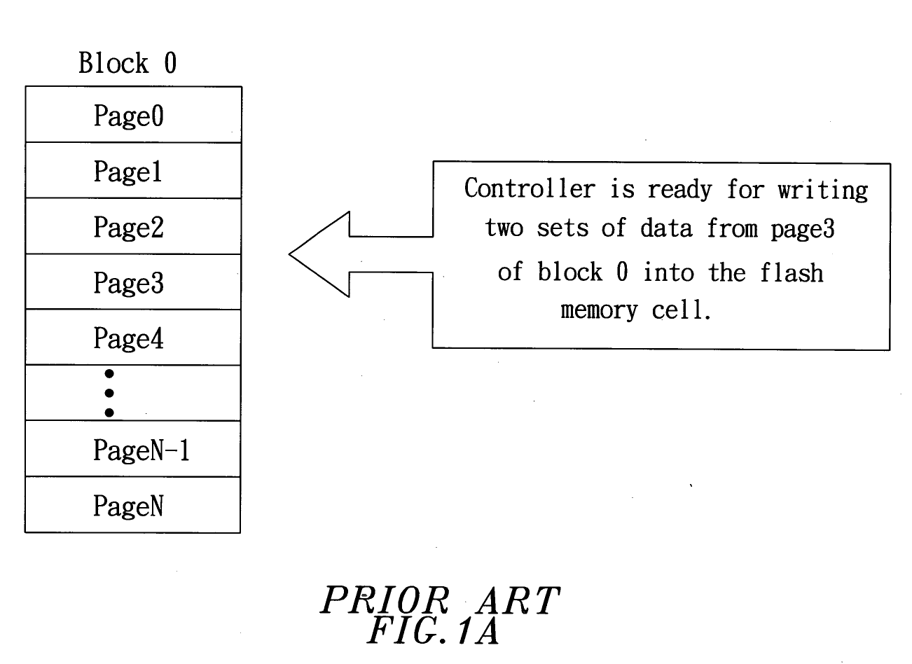

FIG. 1B is an operation process flowchart (2) of the conventional method for writing two sets of data into page 3 of the block 0;

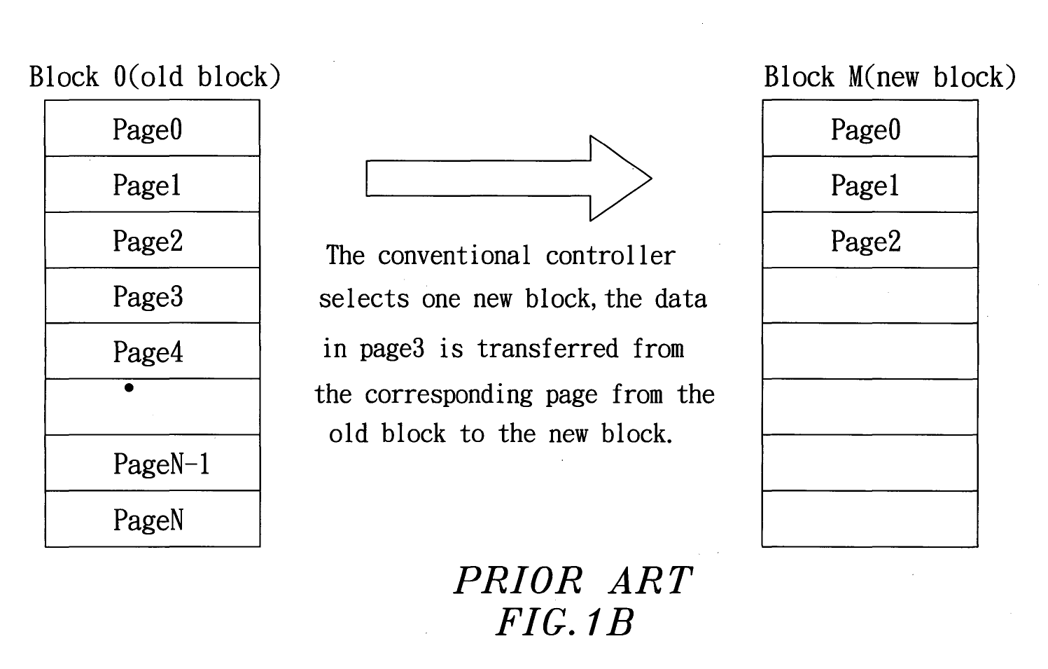

FIG. 1C is an operation process flowchart (3) of the conventional method for writing two sets of data into page 3 of the block 0;

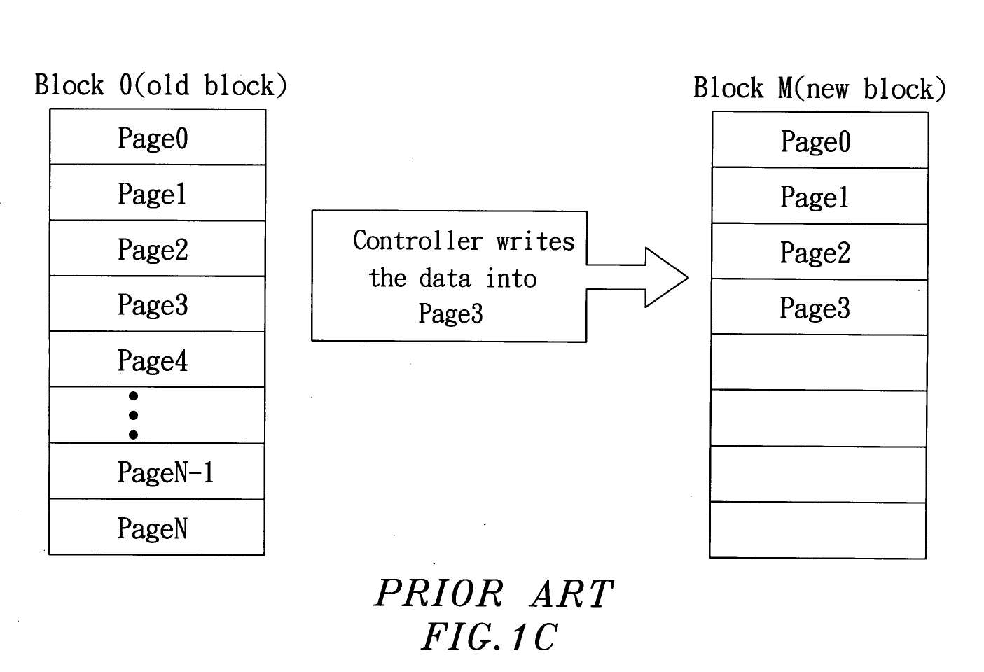

FIG. 1D is an operation process flowchart (4) of the conventional method for writing two sets of data into page 3 of the block 0;

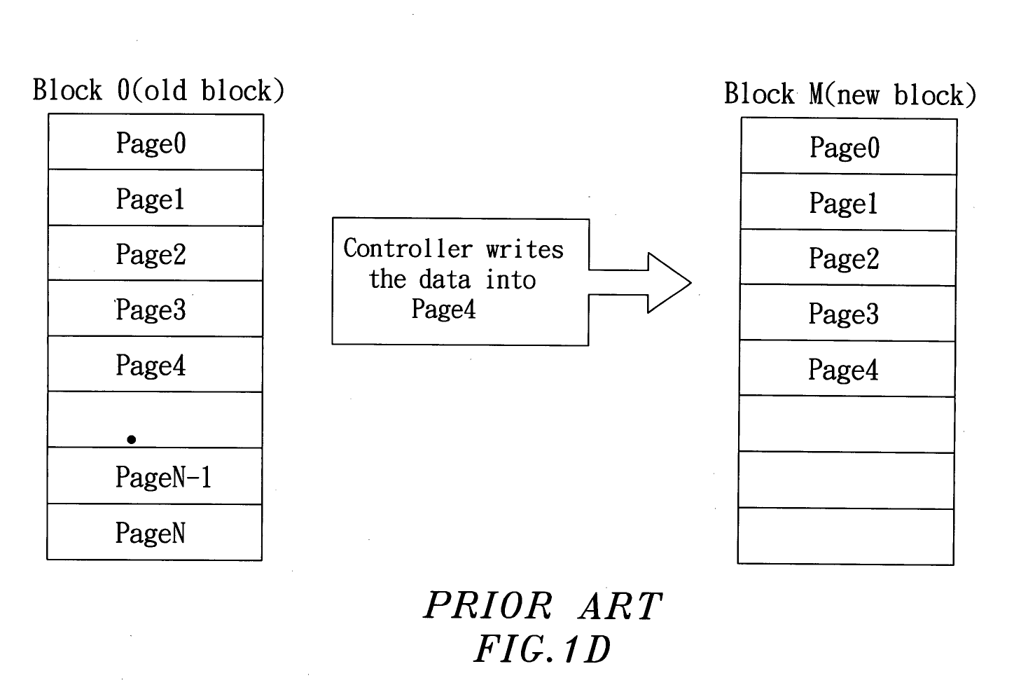

FIG. 1E is an operation process flowchart (5) of the conventional method for writing two sets of data into page 3 of the block 0;

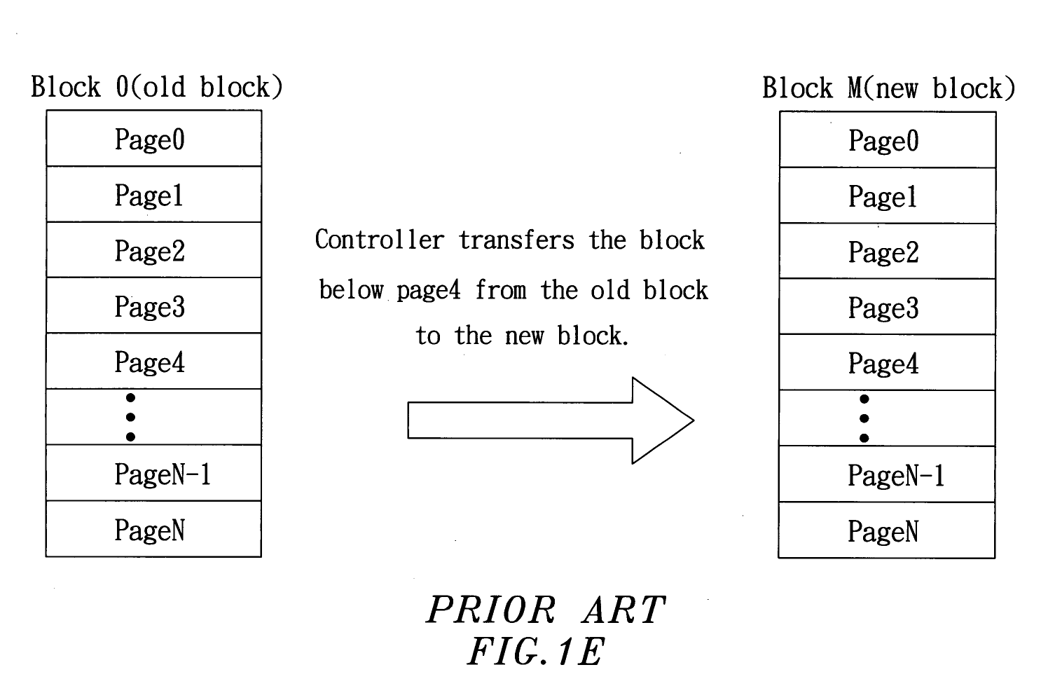

FIG. 1F is an operation process flowchart (6) of the conventional method for writing two sets of data into page 3 of the block 0;

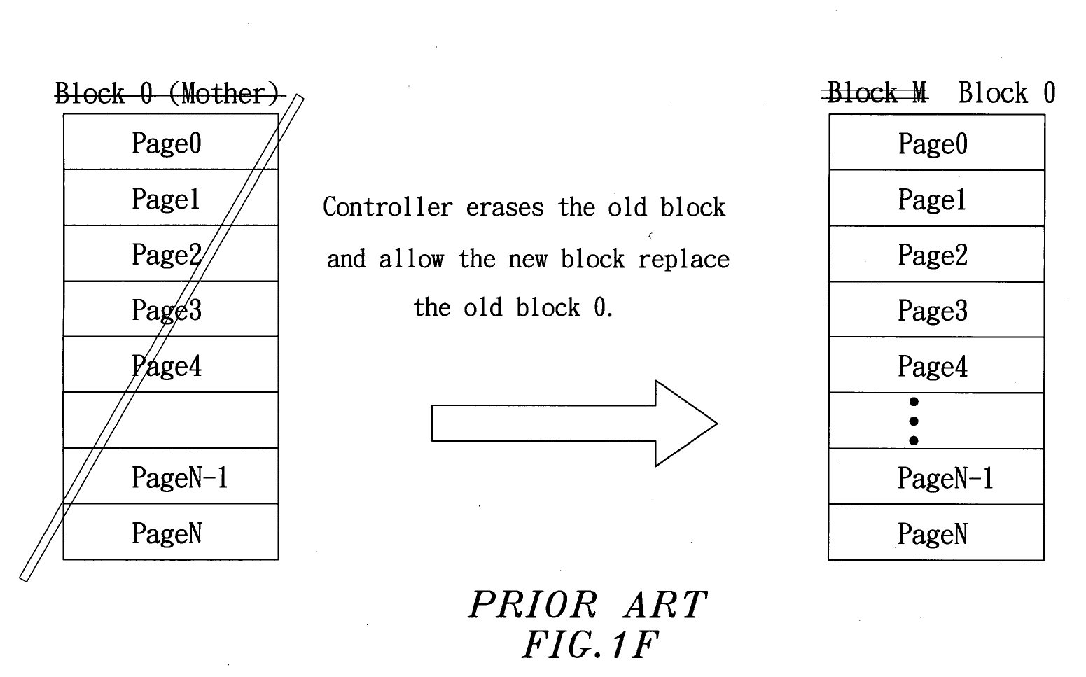

FIG. 2 is a process flowchart of the interleaving management method using two flash memory cells;

FIG. 3 is a process flowchart of the interleaving management method using four flash memory cells to write data;

FIG. 4 is an arrangement of the flash memory cells while using interleaving management method to manage I_page of I_block;

FIG. 5 is an arrangement of the flash memory cells while using interleaving management method to manage I_block of I_zone;

FIG. 6A is an address distribution flowchart (1) showing the physical address with the interleaving management method of the present invention;

FIG. 6B is an address distribution flowchart (2) showing the physical address with the interleaving management method of the present invention;

FIG. 7 is a procedure of a host reading data from the flash memory cell; and

FIG. 8 is a procedure of a host writing data into the flash memory cell.

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

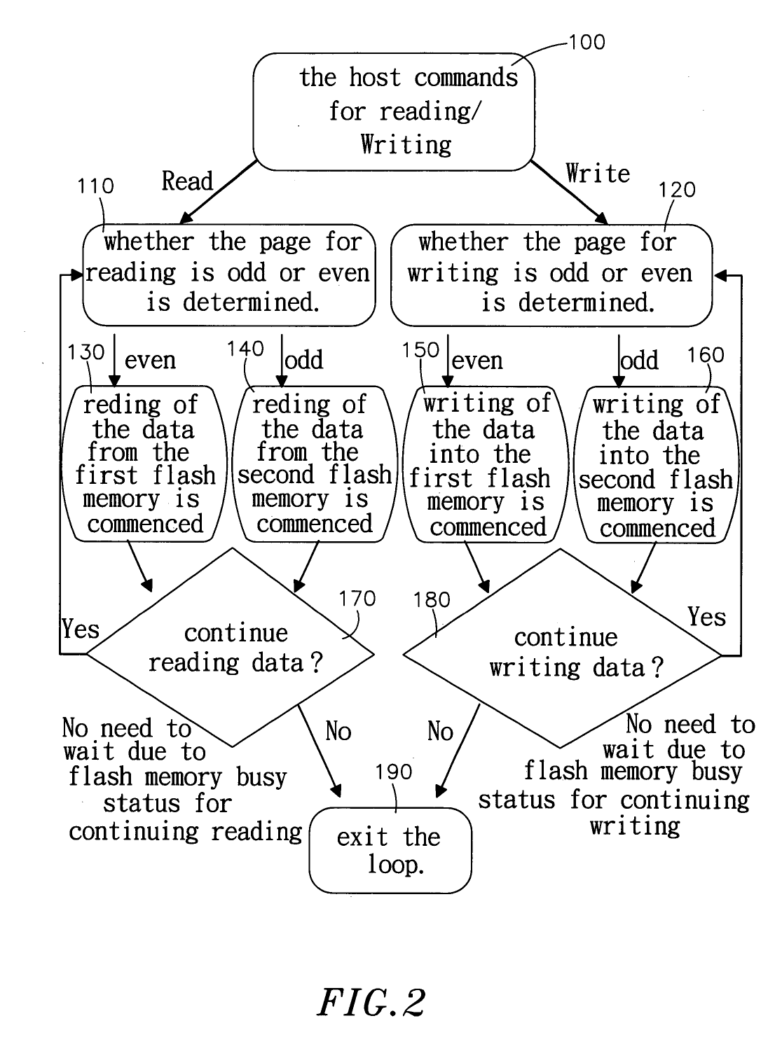

Referring to FIG. 2, illustrates a flowchart of an interleaving method using two flash memory cells according to one preferred embodiment of the present invention. The interleaving method comprises arranging even pages to a first flash memory cell and odd pages to the second flash memory cell. Thus during the writing data to the first flash memory cell, for example, writing two or more sets of sectors into the first flash memory cell, the first sector will be input to the first flash memory cell. When the first flash memory cell is in operating condition, the program need not wait until the writing into the first memory cell is complete before commencement of writing a second set of data into the second flash memory cell. In other words, the writing of the second set of data into the second flash memory cell is independent of operating condition of the first flash memory cell and the writing of the second set of data into the second flash memory cell can be performed while the writing into the first flash memory cell is a ongoing process. Likewise for writing into a third sector of the first flash memory cell, the writing of the second set of data into the second flash memory cell need not be completed. In other words, while the writing of the second set of data into the second flash memory cell is an ongoing process, the first flash memory cell is enabled for writing of the third sector of the first flash memory cell. Accordingly, the data processing time can be substantially shortened.

The detailed data processing according the above embodiment of the present invention is described as follows.
In Step (100), the host commands for reading/writing, in step (110) the host commands for reading and in step (120) the host commands for writing.
In step (110), whether the page for reading is odd or even is determined, if the page for reading is even, then the process proceeds to step (130), and if the page is odd, then the process proceeds to step (140).
In step (120), whether the page for writing is odd or even is determined, if the page is even, then the process proceeds to step (150), and if the page is odd, then the process proceeds to step (160) odd.
In step (130), reading of the data from the first flash memory cell is commenced and then process proceeds to step (170).
In step (140), reading of the data from the second flash memory cell is commenced and then the process proceeds to step (170).
In step (150), writing of the data into the first flash memory cell is commenced and then the process proceeds to step (180).
In step (160), writing of the data into the second flash memory cell is commenced and then the process proceeds to step (180).
In step (170), whether to continue reading data is determined, if yes, the process returns to step (110), if not, the process skips to step (190).
In step (180), whether to continue writing data is determined, if yes, the process returns to step (120), if not, the process skips to step (190).
In step (190), the process ends and the process exits the loop.

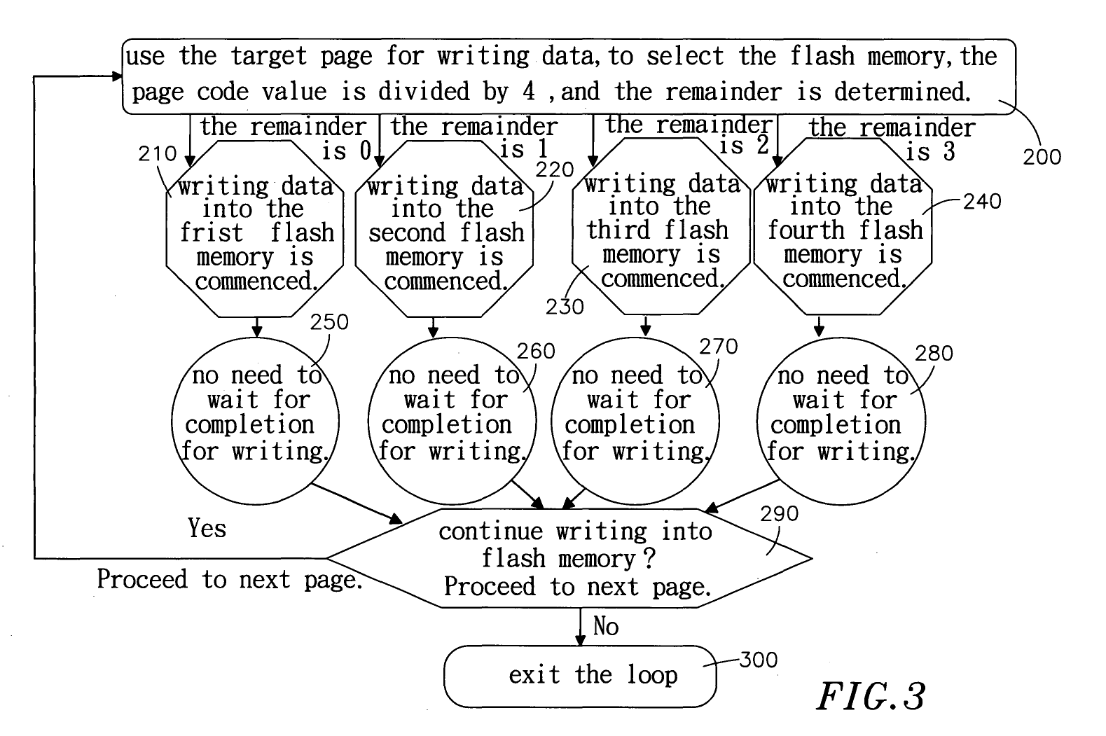

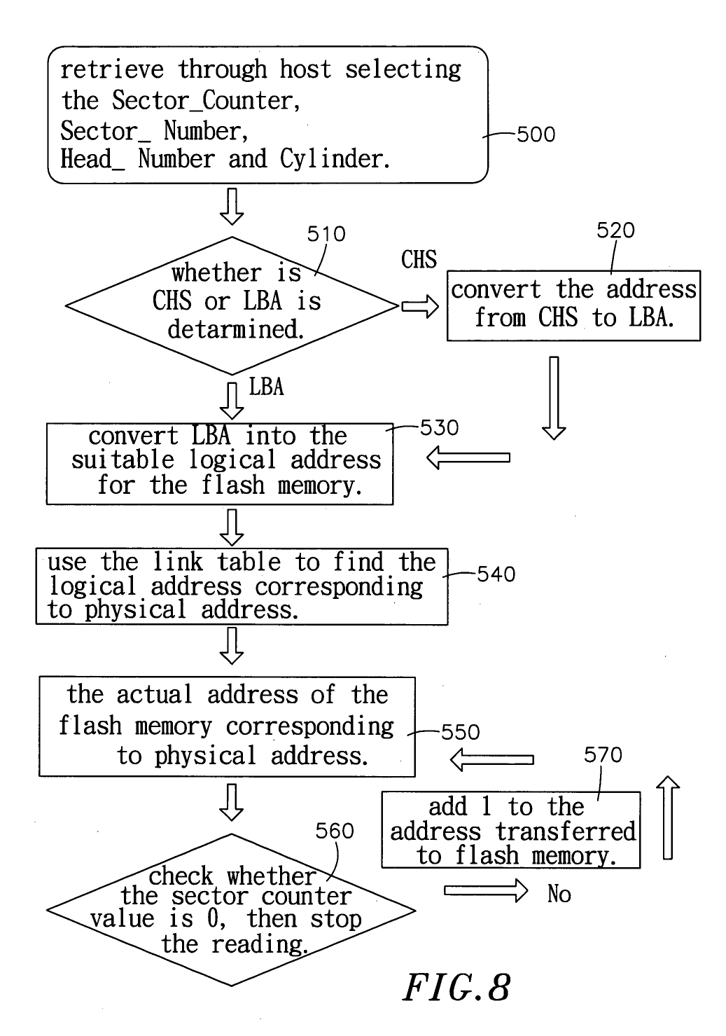

Referring to FIG. 3, illustrates the process flowchart of the interleaving management method using four flash memory cells to write data according one preferred embodiment of the present invention. This drawing is equivalent to the step (550) and (570) of FIG. 8. FIGS. 2 and 3 illustrate a method for writing data into the next page, in which the method that do not use the interleaving management method has to wait for writing into the next page until the previous writing data into the flash memory cell is completed, and the method that use the interleaving management method need not wait for writing data into the next page until the previous writing data into the flash memory cell is completed. Accordingly, the interleaving management method of the present substantially shortens the writing time.

Referring to FIG. 3 again, the method of writing according to one preferred embodiment of the present invention is described as follows.
In step (200), the page for writing data is selected, and the page code value is divided by 4, if the remainder is 0 then the process proceeds to step (210). If the remainder is 1, then the process proceeds to step (220). If the remainder is 2, then the process proceeds to step (230). And if the remainder is 3, then the process proceeds to step (240).
In step (210), writing data into the first flash memory cell is commenced, then the process proceeds to step (250).
In step (220), writing data into the second flash memory cell is commenced, then the process proceeds to step (260).
In step (230), writing data into the third flash memory cell is commenced, then the process proceeds to step (270).
In step (240), writing data into the fourth flash memory cell is commenced, then the process proceeds to step (280).
In the step (250), the process proceeds to step (290) without waiting for completion of the ongoing writing step.
In step (260), the process proceeds to step (290) without waiting for completion of the ongoing writing step.
In step (270), the process proceeds to step (290) without waiting for completion of the ongoing writing step.
In step (280), the process proceeds to step (290) without waiting for completion of the ongoing writing step.
In step (290), whether to continue the writing step is determined, if yes, then the writing data into the next page is commenced and the process returns to step (200), or proceeds to step (300).
The process ends in step (300) and exits the loop.

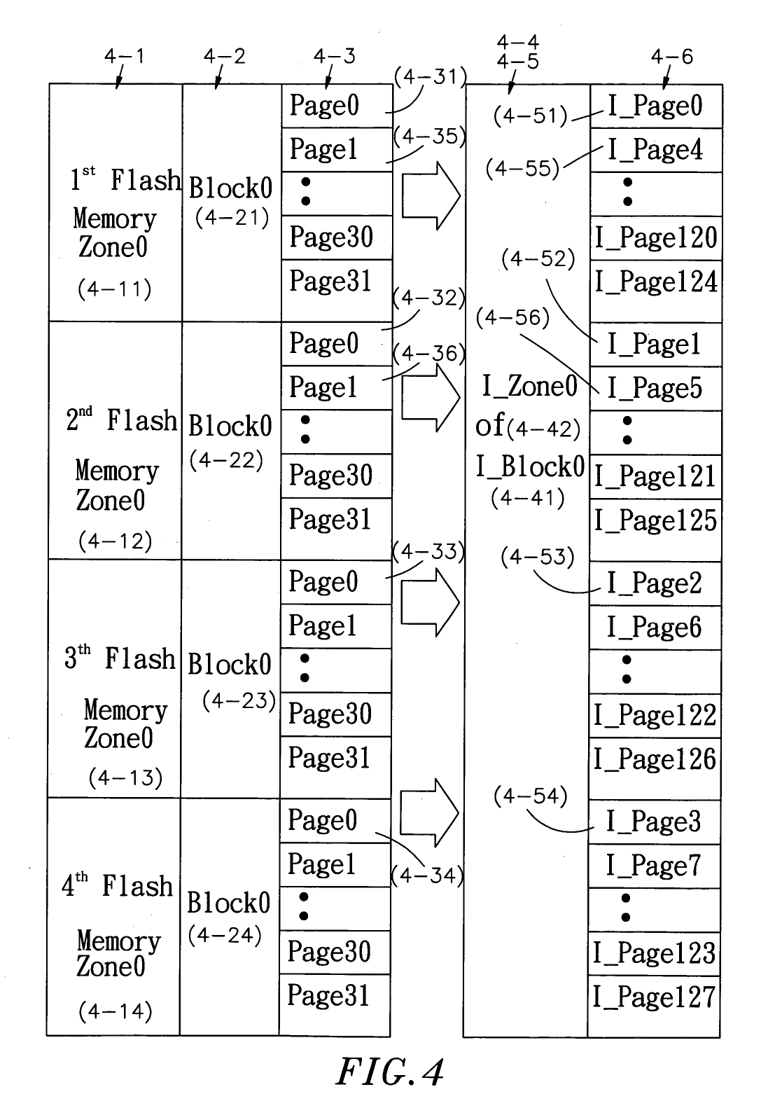

Referring to FIG. 4, illustrates the interleaving management method applied to the flash memory cell for managing I_page of I_block. For the purpose of more detailed illustration, the physical address of the flash memory may be indicated by zone (4-1), block (4-2) and page (4-3), and the physical address of the interleaving management is indicated by I_zone (4-4), I_block (4-5) and I_Page (4-6).

A 64 mb flash memory cell contains 4 zones, each zone contains 1024 blocks, and each block contains 32 pages. In the usual data management procedure of the flash memory cell, the data stored within needs to be transferred constantly, and the controller reads and writes to the flash memory cell often as well, thus the flash memory cell will stay in busy mode all the time. For upgrading the speed, the new generation of the flash memory cell includes a new copy back command. When the flash memory cell receives the copy back read command, the flash memory cell does not read the data, instead the flash memory cell transfers the data into an internal buffer, and then when the flash memory cell receives the copy back write command, the flash memory cell will write the data stored temporary in the internal buffer. The time spent for finishing the above procedure is substantially less than reading and then writing the data. The flash memory cell recognized copy back command is divided into four planes, and therefore, the flash memory cell with capacity 64 (10⁶) mb or more supports copy back command. For the purpose of illustrating the above mentioned procedure using two 64 mb flash memory cells is described as an example below.

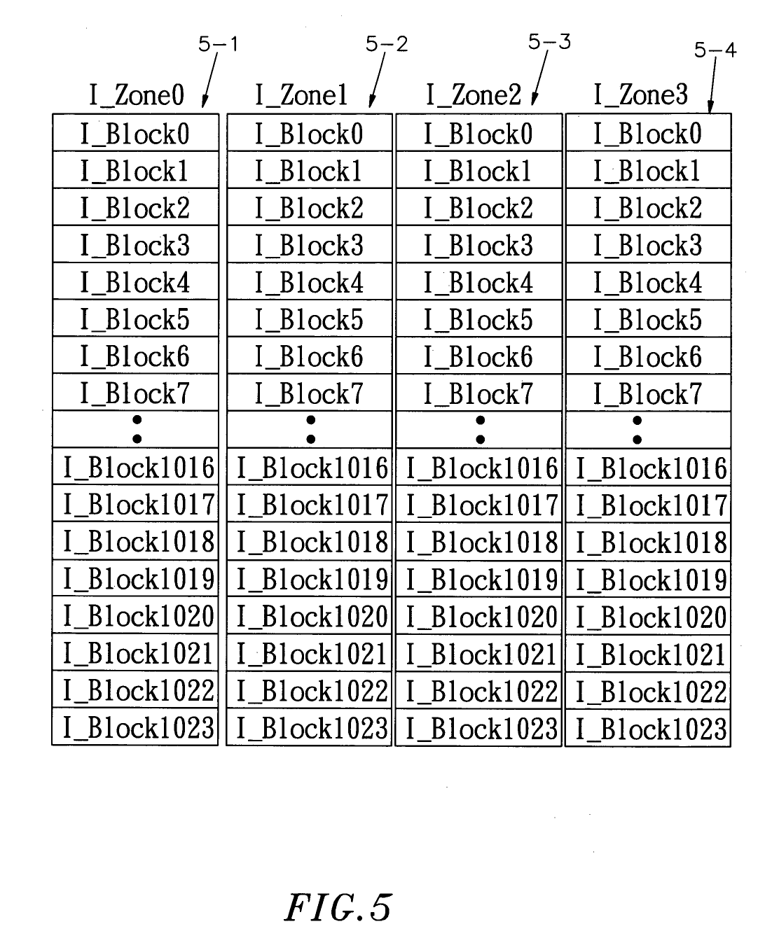

Referring to FIGS. 4 and 5, shows the arrangement of the flash memory cells while using interleaving management method to manage zone 0 (4-11) of each flash memory cell into I_zone 0 (4-41), and I_zone 1 in each flash memory cell belonging to zone 1. Accordingly divide into four large blocks as I_zone 0 (5-1), I_zone 1(5-2), I_zone 2 (5-3) and I_zone 3 (5-4), wherein I_zone (4-4) still contains 1024 I_blocks (4-5) and each I_block (4-5) belonging to the same block of the four flash memories. Therefore, each I_page (4-6) of I_block (4-5) is four times of a block, in other words, an I_block (4-5) contains 128 I_Pages (4-6), and the interleaving structure consisted by four 64 mb flash memories comprises four I_zones (4-4), each I_zone (4-4) comprises 1024 I_blocks (4-5), and each I_blocks (4-5) has 128 pages (4-6).

The total capacity of the above arrangement is 4*1024*128*512 bytes, and it is equal to 64*4 mb. The distribution is arranged in terms by the pages of the four blocks within I_block (4-5). Using I_block 0 (4-42) of I_zone 0 (4-41) as an example, I_page 0 (4-51) of I_block 0 (4-42) in the physical address is distributed to page 0 (4-31) of block 0 (4-21) of zone 0 (4-11) in the first flash memory cell, and I_page 1 (4-52) is distributed to page 0 (4-32) of block 0 (4-22) of zone 0 (4-12) in the second flash memory cell; I_page 2 (4-53) is distributed to page 0 (4-33) of block 0 (4-23) of zone 0 (4-13) in the third flash memory cell; and I_page 3 (4-54) is distributed to page 0 (4-34) of block 0 (4-24) of zone 0 (4-14) in the fourth flash memory cell. And the I_page 4 (4-55) is distributed back to page 1 (4-35) of block 0 (4-21) of zone 0 (4-11) of the first flash memory cell, and I_page 5 is distribute again to page 1 (4-36) of block 0 (4-22) of zone 0 (4-12) in the second flash memory cell accordingly.

In a case where the copy back command is not utilized in the file management, the physical address arrangement shown in FIGS. 4 and 5 will be the final physical address. However, in a case where the copy back command in the file management is utilized, the physical arrangement is required to be modified in the upward direction. The arrangement to the flash memory cell while using interleaving management method to manage I_zone, I_block and I_page with copy back command, the physical address will be changed into I_C_zone, I_C_block and I_C_page.

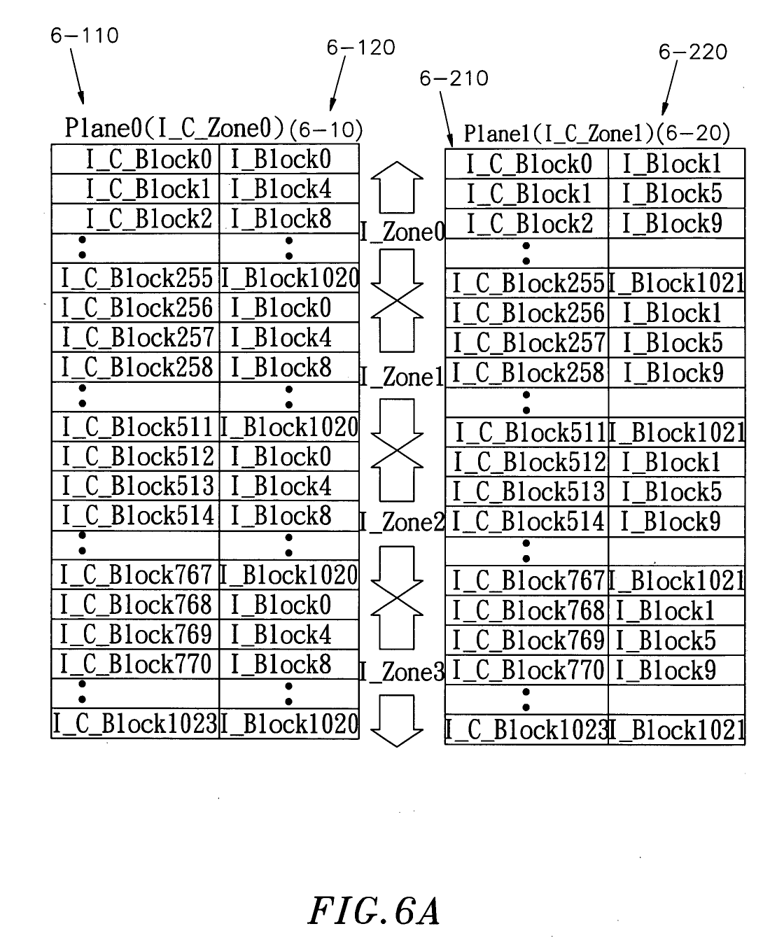

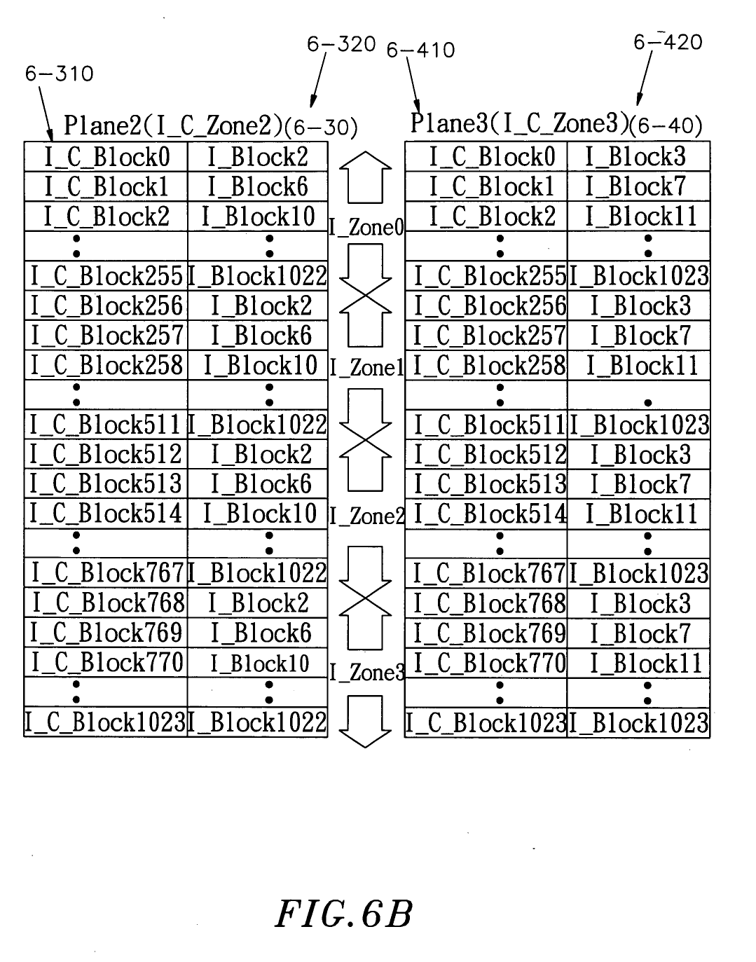

Furthermore, referring to FIGS. 6A and 6B, are the address distribution charts 1 and 2 showing the physical address with the interleaving management method of the present invention. The embodiment of the present invention interleaves flash memory cells with the new copy back command. The management with the new copy IO back divides the flash memory cell into four planes, only I_C_block in the same plane is able to accept copy back command, I_C_block (6-110) of plane 0 (6-10) includes all the 4n+0 (0≦n≦255) I_block (6-120) of I_zone, I_C-block (6-210) of plane 1 (6-20) includess all the 4n+1 (0≦n≦255) I_block (6-220) of I_zone; I_C_block (6-310) of plane 2 (6-30) includes all the 4n+2 (0≦n≦255) I_block (6-320) of I-zone; I_C block (6-410) of plane 3 (6-40) includes all the 4n+3 (0≦n≦255) I_block (6-420) of I_zone; and plane 0 can be taken as a new I_C_zone 1 0 (6-10) and plane 1 can be taken as a new I_C zone 1 (6-20) and so on. Thus the physical address in this file management is different from the actual address of the flash memory. However, with interleaving and copy back management, the physical address mentioned hereinafter is substantially different from the flash memory cell. Before using the flash memory, it is must to find the logical address corresponding to the physical address of the flash memory cell. The correspondent of the logical and physical position is called link table.

And because this management structure is based the mother and child concept, there is a possibility that two physical positions in a flash memory correspond to the same logical position. In this situation, the controller has to judge which one of these two physical positions belongs to the mother and which one of these two physical positions belongs to the child, and then combine the mother and child together, fill up the rest of pages of the child by the pages of the mother then erase the mother. Thus the logical and physical positions in the link table are corresponding to each other one after another. When the link table is set and the host requests a logical position to the flash memory, the controller can locate the corresponding physical position in the flash memory promptly and process. The initialization is not only for building up a link table, but also for marking those blocks that has no logic or being processed inappropriately for back up blocks.

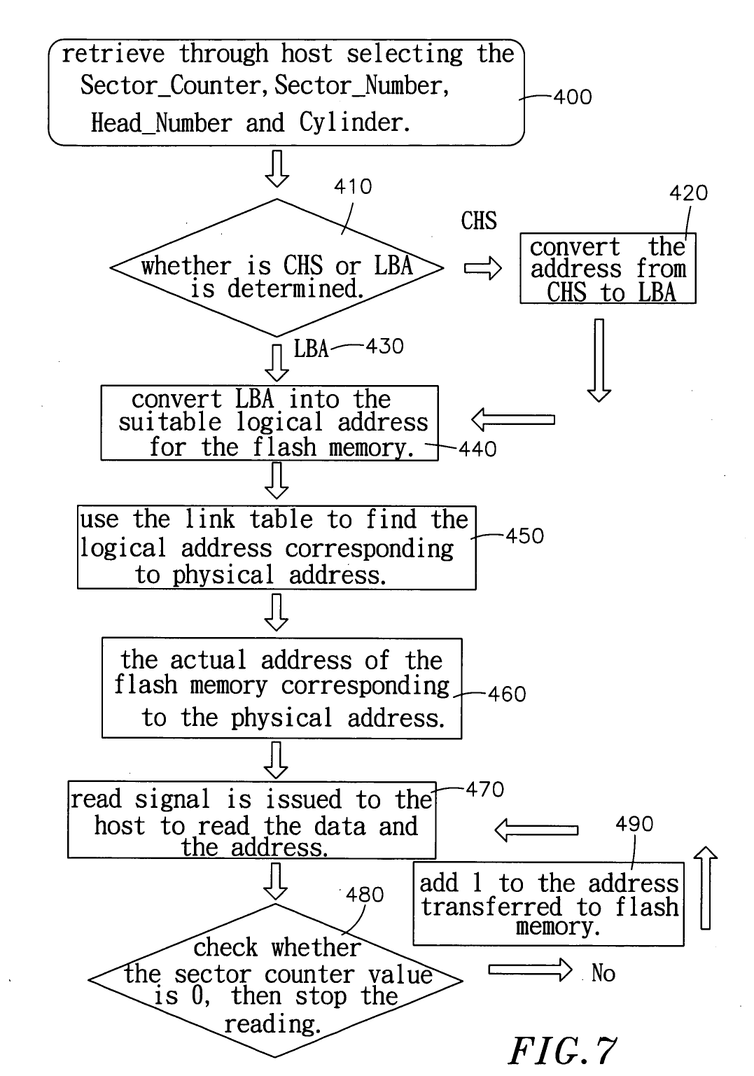

Referring to FIG. 7 is a process flowchart illustrating a host reading data from a flash memory.

Step 1, retrieve through host the Sector_Counter, Sector_Number, Head_Number and Cylinder (400), whether is CHS or LBA (410) is determined, wherein 0 is for CHS and 1 is for LBA, if it is determined to be LBA, then the process proceeds to step (430) for LBA, or to step (420) if it is determined to be CHS.

The manner of converting LBA and CHS is described as below: LBA=(((Track*Head_per-Track)+Head_Num)*Sector_per-Head)+Sector_Num)−1.
Remarks:
   a. the parameters of the above formula is in CHS;
   b. track: which cylinder;
   c. Head_per_Track: how many heads is a track;
   d. Head_Num: which head;
   e. Sector_per-Head: how many sectors in a head
   f. Sector_Num: which sectors;
   g. the result in LBA converted by the formula indicates what sector the very address is; and
   h. sector counter: how many sets of data have to transmit to the host.

Step 2, calculates the address that the LBA is pointing at, by checking how many zones does the flash memory cell has, and how many blocks in a zone, how many pages in a block (a page is equal to a sector) (440), and the resulting address is the so-called logical address, then checking which page of which block and in which zone this logical address is located to match with link table for finding the corresponding physical address (450);
Step 3, the actual address of the flash memory cell corresponding to the physical address (460) can be found by using the converting method shown in FIGS. 4, 5, 6A and 6B, then read signal is issued to read the data and the address from the flash memory cell (470);
Step 4, if in case, the previous set of data in the address of the page of the flash memory cell is not the last page, in order for commanding the flash memory cell to read the next set of data, the value of the page in the address is set at previous address value plus 1 (490). And if the previous set of data is in the last page, in order for commanding the flash memory cell that this set of data is in the last page, the value of the page in the address is set equal to 0 (480), and the value of the block is set at previous address value plus 1; the rest shall be calculated accordingly. If the previous set of data address is in the last page and last block, in order for commanding the flash memory cell this set of data is the last page, the value of the old page and block of the address will be 0, and the value of the zone is the previous address value plus 1. And if the zone, block and page are all last one, but the sector-counter is not 0, then the controller will inform an error to the host.

Referring to FIG. 8, is a process flowchart illustrating a host writing data to a flash memory.

Step 1, retrieve through host selecting the Sector_Counter, Sector_Number, Head_Number and Cylinder (500), whether is CHS or LBA (510) is determined, wherein 0 is for CHS and 1 is for LBA. If it is determined to be CHS, then the process proceeds to step (520).

The manner of converting LBA and CHS is described as below: LBA=(((Track*Head_per Track)+Head_Num)*Sector_per Head)+Sector_Num)−1.
Remarks:
   a. the parameters of the above formula is in CHS;
   b. track: which cylinder;
   c. Head_per_Track: how many heads is a track;
   d. Head_Num: which head;
   e. Sector-er-Head: how many sectors in a head
   f. Sector_Num: which sectors;
   g. the result in LBA converted by the formula indicates what sector the very address is; and
   h. sector counter: how many sets of data have to transmit to the host.

Step 2, calculates the address that the LBA is pointing at, by checking how many zones the flash memory cell has, and how many blocks in a zone, how many pages in a block (a page is equal to a sector) (530), and the resulting address is the so-called logical address, then checking which page of which block and in which zone this logical address is located to match with link table for finding the corresponding physical address (540).

Step 3, the actual address of the flash memory cell corresponding to the physical address (550) can be found by using the converting method shown in FIGS. 4, 5, 6A and 6B. The controller is unable to let the host write to the flash memory cell directly, and the back up block in the initialization of the flash memory cell will be used herein. First of all, the controller marks the block to be written for writing data as mother, and move out a back up block and mark it as child, then input a logical address into the child which is same as mother's. Secondly, the controller read out the pages above the page to be read from the mother to the child, for example, if the page to be read is N page, the controller reads out from page 0 to page N−1 from the mother then writes the data into the child, such read/write action is accomplished using the copy back command. Therefore the data of the mother will be actually read out from the flash memory, instead of storing the data into the internal buffer of the flash memory and then write to the child from the buffer. Furthermore, the controller writes the data retrieved from the host to the target page (as the example N page), for doing so, the controller judges whether the sector counter indicating is the last set of data, if yes, the writing action is over; if not, the next set of data will be written into page N+1 of the child directly. And when the page address for writing is for the last set, the mother data will be useless now, and the controller will erase the block marked as mother. When processing the next set of data, the controller will move a block which is marked as child from the back up blocks and repeats the above procedures.

Step 4, if the previous set of data in the address of the page of the flash memory is not the last page, in order for commanding the flash memory cell for reading the next page, the value of the next page address is set at previous address value plus 1 (570), and if the previous set of data is in the last page, in order for commanding the flash memory that this set of data is in the last page, the value of this page address is set equal to 0 (560), and the value of the block is set at previous address value plus 1. The rest shall be calculated accordingly. If the previous set of data address is in the last page and in last block, in order for commanding the flash memory the same, the value of the old page and block of the address will be set at 0, and the value of the zone is the previous address value plus 1. And if the zone, block and page are all last one, but the sector-counter is not 0, then the controller will inform an error to the host.

Furthermore, the interleaving management method of the present invention can also be suitable applied in any hosting device, such as a portable ROM, a card reader in USB1.1 series, or a portable ROM, a card reader in USB2.0 series, or an IDE/PCMCIA interface.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

1. An interleaving management method for upgrading a data processing speed of a flash memory, comprising a plurality of flash memory cells, wherein each of said flash memory cells comprises a plurality of blocks for reading and writing data and a plurality of pages in each said blocks, the method comprising:
continuously writing data into said plurality of flash memory cells, wherein when writing two or more sets of sectors into said plurality of flash memory cells, write a first sector into a first flash memory cell, and while the process of writing said first sector into said first flash memory cell is ongoing, a second flash memory cell is enabled so that a second sector can be written into said second flash memory cell.

2. The interleaving management method according to claim 1, wherein said a plurality of flash memory cells for writing data continuously are arranged in an interleave structure.

3. The interleaving management method according to claim 1, wherein said plurality of flash memory cells is used in a mother and child structure, said mother and child structure possessing two physical features constitute one logical address, so that for writing data, transferring and erasing steps in said flash memory cells can be avoided, thus a life time of said flash memory cells can be extended and also data processing speed of said flash memory cells can be increased.

4. The interleaving management method according to claim 2, wherein said flash memory cells are arranged in a group constituting the interleaving structure, correspondingly using copy back command, wherein a 64 mb flash memory cell is divided into four zones, each zone has 1024 blocks and each block has 32 pages, and four 64 mb flash memory cells constituting said interleaving structure comprises 4 zones, wherein each zone has 1024 blocks and each block has 128 pages.

5. The interleaving management method according to claim 1, wherein said interleaving management method for managing data processing of a plurality of flash memory cells is suitably applied in a hosting device, wherein said hosting device comprises, a portable ROM, a card reader in USB1.1 series, or a portable ROM, card reader in USB2.0 series, or an IDE/PCMCIA interface.
